(19) United States
(12) Patent Application Publication
(10) Pub. No.: US 2009/0158738 A1
(43) Pub. Date: Jun. 25, 2009

(54) METHODS AND APPARATUS FOR STARTING UP COMBINED CYCLE POWER SYSTEM

(76) Inventors: Tailai Hu, Greenville, SC (US); Robert Joseph Iasillo, Simpsonville, SC (US); Gordon R. Smith, Ballston Spa, NY (US); Kelvin Rafael Estrada, Gaffney, SC (US)

Correspondence Address: JOHN S. BEULICK (17851);ARMSTRONG TEASDALE LLP, ONE METROPOLITAN SQUARE, SUITE 2600, ST. LOUIS, MO, 63102-2740, US

(21) Appl. No.: 12/197,712

(22) Filed: Aug. 25, 2008

Related U.S. Application Data
(60) Provisional application No. 61/015,425, filed on Dec. 20, 2007.

(51) Int. Cl. F02K 5/00

(52) U.S. Cl. 60/646

(57) ABSTRACT

Methods and apparatus for fast starting and loading a combined cycle power system are described. In one example embodiment, a method for starting a combined cycle power generation system is provided. The system includes a gas turbine and a steam turbine. The method includes loading the gas turbine at a loading rate that is facilitated to be at an increased loading rate, setting a first predetermined value for a bypass pressure set point for high-pressure steam, and increasing the first predetermined value to a second predetermined value at a predetermined rate.

### CROSS REFERENCE TO RELATED APPLICATIONS

This patent application claims priority to U.S. Provisional Patent Application Ser. No. 61/015,425, filed on Dec. 20, 2007, which is hereby incorporated by reference in its entirety.

### BACKGROUND OF THE INVENTION

The field of this invention relates generally to combined-cycle power generation systems and more specifically, to methods and apparatus that facilitate fast starting and loading such systems.

As is known in the art, combined cycle power systems include one or more gas turbines and heat recovery steam generators (HRSG) and a steam turbine. Known combined cycle system startup procedures require low load holds of the gas turbine and place restrictions on the gas turbine loading rate to control the rate of increase in steam temperature. Such holds and restrictions contribute to air emissions during the startup event, may increase starting and loading times, and may increase fuel consumption during starting and loading.

More specifically, with known combined cycle systems, during starting and loading, prior to the gas turbine achieving full load, the gas turbine is put on a hold until the temperature of the steam generated by the HRSG substantially matches the steam turbine high pressure and intermediate pressure bowl metal temperature, until the HRSG is warmed at a predetermined rate, and/or until the HRSG is warmed to a temperature wherein it is ready for fuel heating. By holding the gas turbine at a low load, generally the gas turbine operates at a low efficiency and with higher exhaust emissions. Furthermore, in known systems, the steam bypass pressure set point is traditionally set to a floor pressure, i.e., a HRSG manufacturer parameter, or to an existing pressure, whichever is higher. The pressure set point is typically maintained at a constant value during steam admission into the steam turbine.

Such traditional starting procedures have been tolerated at least in part because in the past, startups were infrequent. However, with day-to-night power price swings, such startups have become more frequent. Moreover, a trend has been increasing to use combined cycle power plants as daily peaking units because of the periodical changes of the demand and the natural gas price. As described above, the increase in startups has created an increase in the desirability of starting up combined cycle power systems faster and with higher efficiency and lower emissions. In addition, spinning/non-spinning reserve credits are given to peaking units and driven by dispatch ranking. Accordingly, a faster startup is preferred.

### BRIEF DESCRIPTION OF THE INVENTION

In one aspect, a method for starting a combined cycle power generation system is provided. The system includes a gas turbine and a steam turbine. The method includes loading the gas turbine at a loading rate that is facilitated to be at an increased loading rate, setting a first predetermined value for a bypass pressure set point for high-pressure steam, and increasing the first predetermined value to a second predetermined value at a predetermined rate.

In another aspect, a combined-cycle power generation system is provided. The system includes a gas turbine that is coupled to a first generator, a steam turbine that is coupled to a second generator, and a heat recovery steam generator coupled to the steam turbine and the gas turbine. The heat recovery steam generator for supplying steam to the steam turbine. The system also includes at least one pressure controller that is coupled in flow communication with the heat recovery steam generator. The pressure controller is set at a first predetermined value for a bypass pressure set point and is varied such that the first predetermined value is increased to a second predetermined value at a predetermined rate.

In yet another aspect, a method for starting a combined cycle power generation system is provided. The system includes a gas turbine and a steam turbine. The combined cycle system also includes a heat recovery steam generator, a condenser connected to the steam turbine, and a plurality of bypass paths extending from the heat recovery steam generator to the condenser and from the high-pressure steam piping to the hot reheat steam piping. Moreover, the system also includes at least one pressure controller that is coupled in flow communication with at least one steam bypass path. The method includes loading the gas turbine at an increased loading rate and loading the steam turbine using variable pressure steam. The steam turbine is loaded using variable pressure steam by setting a bypass pressure set point for high-pressure steam at a first predetermined value using the at least one pressure controller, and increasing the bypass pressure set point to a second predetermined value at a predetermined rate using the at least one pressure controller.

### BRIEF DESCRIPTION OF THE DRAWINGS

FIG. 1 is a schematic illustration of an exemplary combined cycle power system.

FIG. 2 is a flow chart of an exemplary method of operating the combined-cycle power system shown in FIG. 1.

### DETAILED DESCRIPTION OF THE INVENTION

While the methods and apparatus are herein described in the context of a combined cycle power system used in an electric utility power generation environment, it is contemplated that the methods and apparatus described herein may find utility in other applications. In addition, the principles and teachings set forth herein are applicable to turbines that use a variety of combustible fuels such as, but not limited to, natural gas, gasoline, kerosene, diesel fuel, and/or jet fuel. In addition, the methods and apparatus described herein can be utilized in connection with both multi-shaft and single-shaft combined cycle systems. The description hereinbelow is therefore set forth only by way of illustration, rather than limitation.

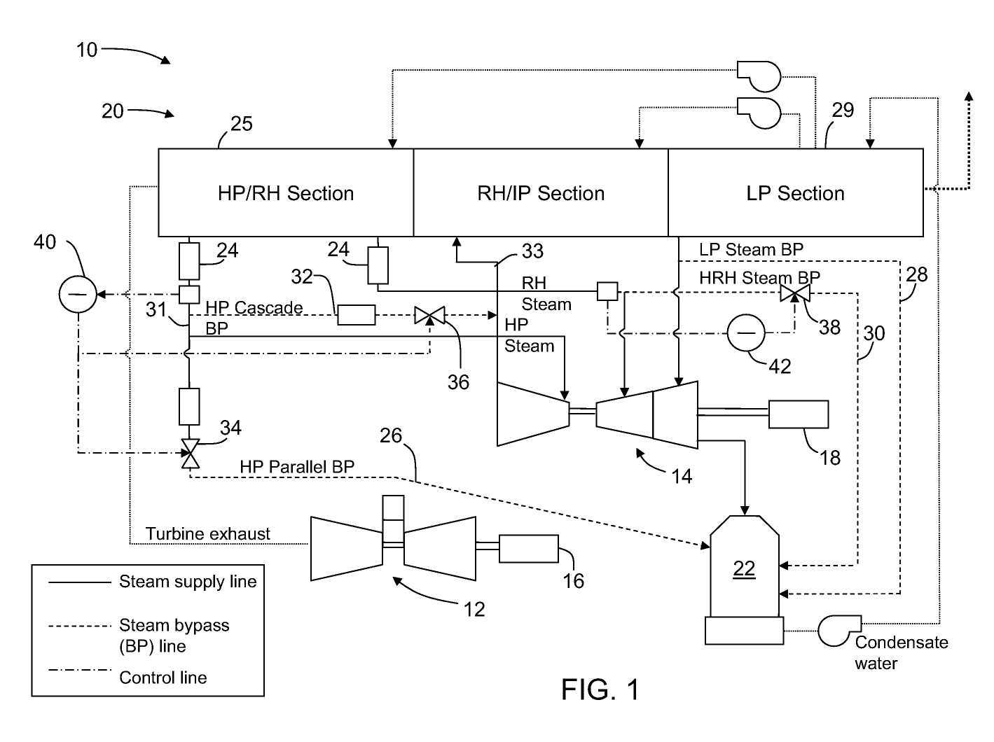

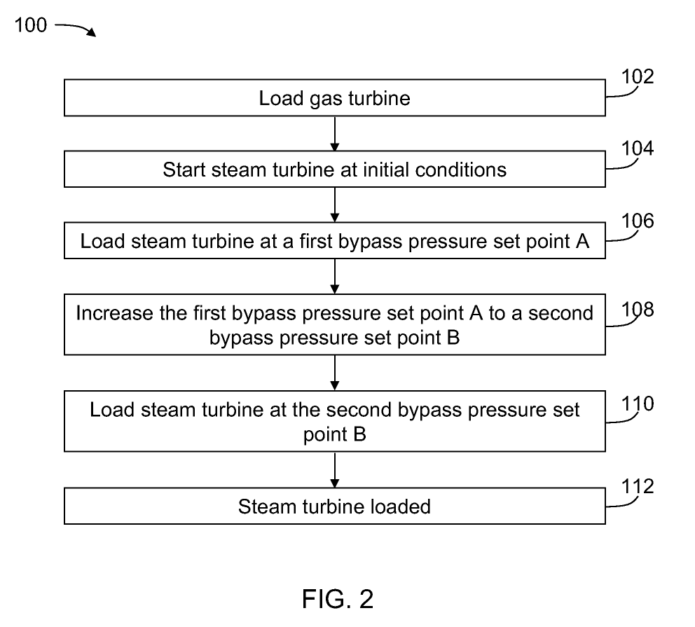

FIG. 1 is a schematic illustration of an exemplary combined cycle power system 10. FIG. 2 is a flow chart of an exemplary method 100 of operating combined-cycle power system 10. System 10 includes a gas turbine 12 and a steam turbine 14 coupled to respective generators 16 and 18. Steam turbine 14 is coupled via multiple conduits to a heat recovery steam generator (HRSG) 20 and at its exhaust to a condenser 22. In the embodiment, system 10 also includes attemperators 24 at the discharge terminal of the high-pressure superheater/reheater 25. HRSG 20 may include a once-through or a drum type evaporator that is capable of tolerating daily startup and loading of gas turbine 12 at an optimized rate, with a normal life span, and with normal or expected maintenance.

System 10 further includes bypass paths 26, 28, and 30 that extend from HRSG 20 to condenser 22, and also includes a high-pressure (HP) cascade bypass path 32 that extends from the high-pressure steam line 31 to cold reheat steam piping 33. More specifically, an HP parallel bypass path 26 is in flow communication with superheater/reheater 25 and condenser 22, a low-pressure (LP) steam bypass path 28 is in flow communication with a low pressure section 29 of HRSG 20 and condenser 22, and a hot reheat (HRH) steam bypass path 30 is in flow communication with superheater/reheater 25 and condenser 22. In the exemplary embodiment, bypass paths 26, 28, 30, and/or 32 provide alternate high-pressure steam flow paths when the steam turbine admission valves are modulated to facilitate loading steam turbine 14 at its fastest allowable rate that, in the exemplary embodiment, is approximately 100% of the rated speed of turbine 14.

In the exemplary embodiment, bypass paths 26 and 32 include valves 34 and 36, respectively, that are modulated to facilitate controlling the pressure of the high-pressure steam and the rate of increase of high-pressure steam pressure. Bypass path 30 includes a valve 38 that is modulated to facilitate controlling the reheat steam pressure when the steam turbine intermediate pressure control valve is modulated during steam turbine loading. Steam bypass path 28 provides an alternate path for low pressure steam when the steam turbine low pressure admission valve is modulated during steam turbine loading.

Moreover, in the exemplary embodiment, system 10 includes a first pressure controller 40 that is coupled in flow communication with bypass paths 32 and 26, and a second pressure controller 42 coupled in flow communication with bypass path 30. More specifically, first pressure controller 40 is coupled in flow communication with valves 34 and 36, and second pressure controller 42 is coupled in flow communication with valve 38. At initial operating conditions, a set point of first pressure controller 40 may either be fixed and/or vary with respect to time. After a predetermined time, a first predetermined set point value A of first pressure controller 40 is determined by using the existing operating pressure in a high-pressure drum, the metal temperature, and/or the pipe length of bypass lines 26 and/or 32. In the exemplary embodiment, first pressure controller 40 is set at a minimum pressure set point. The pressure set point of first pressure controller 40 is increased to a targeted value or second predetermined value B under a preferred rate, as is described in more detail below. Second pressure controller 42 is configured to control a flow of hot reheat steam, as described in more detail below.

In the exemplary embodiment, method 100 facilitates fast starting and loading system 10 and includes loading 102 gas turbine 12 at a predetermined rate, such as an increased loading rate. For example, in the exemplary embodiment, the increased loading rate is between about 13% per minute and about 25% per minute, as compared to a loading rate of about 8% per minute or less for known combined cycle systems. Accordingly, as used herein, the term “an increased loading rate” refers to a loading rate that is greater than about 8.5% per minute. In the exemplary embodiment, gas turbine 12 is loaded 102 using steam pressure management of HRSG 20 and/or steam bypass paths 26, 28, 30, and/or 32. When predetermined conditions are satisfied, gas turbine 12 is loaded 102 at a predetermined loading rate, such as the increased loading rate.

In the exemplary embodiment, during gas turbine loading 102, steam turbine 14 is at initial conditions, including an initial bypass pressure set point. Once gas turbine 12 is loaded 102, steam turbine 14 is started 104 at the initial conditions and beings to load. As steam turbine is started 104, a path of the high-pressure steam bypass pressure set point for steam turbine 14, from an initial condition to a first predetermined value A, can be fixed and/or may vary with respect to time. More specifically, a rate of increase of the set point may be selected based on the operation of system 10. In the exemplary embodiment, a bypass pressure set point for the high-pressure steam is initially set at the first predetermined value A. More specifically, in the exemplary embodiment, the first predetermined value A may be set at a pressure that is lower than a floor pressure, if the existing high-pressure steam pressure is lower than the floor pressure. Steam turbine 14 loads 106 at a bypass pressure set point with the first predetermined value A. The bypass pressure set point is then increased 108 at a predetermined rate to the second predetermined value B.

The start-up method uses high-pressure steam bypass lines to control the conditions in the high pressure drum and superheaters starting from the beginning of the startup, after the purging of the HRSG, if purging is included in the start-up sequence. Alternatively, if the purging is not included in the start-up sequence, the high pressure drum and steam conditions are controlled from the beginning of the startup. The high-pressure steam control from the beginning of startup is achieved by managing the high-pressure steam bypass pressure set points through the predetermined values and the preferred changing rates. The methods described herein facilitate minimizing the high-pressure drum and superheater stresses to reduce the cycling effects during startups. Furthermore, at such predetermined set points, a swelling effect of the high-pressure drum is facilitated to be decreased.

The rate of increase 108 of the bypass pressure set point is limited by an allowed maximum rated value under the high-pressure drum stress control and the flow requirement in bypass lines 26 and/or 32. The predetermined targeted value B is determined by model predictions, experimental data, and/or any suitable method that enables system 10 to function as described herein. Considering system 10 configurations and the thermo-state conditions (hot, warm, cold starts) of system 10, the first and second steam bypass pressure set points A and B and the predetermined rate of increase are facilitated to be optimized based on the conditions in system 10. Additionally, when the high-pressure steam is being admitted to steam turbine 14, a set point of second pressure controller 42 can be increased at a controlled, predetermined rate to allow the hot reheat steam faster admission into steam turbine 14 to facilitate increasing the power generated. In one embodiment, the sliding high-pressure steam bypass pressure set point at the second predetermined value B is set between approximately 60% to approximately 100% of the rated pressure, and preferably set to approximately 75% to approximately 90% of the rated pressure, such that the steam superheat is increased and the steam turbine produces more power, in a shorter startup time, as compared to conventional pressure set points that remain constant. Steam turbine 14 is loaded 110 at a bypass pressure set point with the second predetermined value B. As such, steam turbine 14 is loaded 112 to a final value by loading 106 steam turbine 14 at a bypass pressure set point with the first predetermined value A, and then loading 110 steam turbine 14 at an increased bypass pressure set point with the second predetermined value B.

Additionally, as described above, when the high-pressure steam is admitted to steam turbine 14, a set point of second pressure controller 42, for the bypass line of the hot reheat steam, can be increased at a controlled rate to facilitate faster admission of the hot reheat steam into steam turbine 14. As such, the power generated is facilitated to be increased.

Moreover, during startup 104, 106, 108, and/or 110, a flow of steam through bypass paths 26, 28, 30, and/or 32 is modulated to facilitate controlling the high-pressure steam, reheat steam, and/or the low pressure steam and to facilitate providing alternate paths for the steam from heat recovery steam generator 20 that is not admitted to steam turbine 14 during its loading process. More particularly, during startup, gas turbine 12 is loaded 102 at up to gas turbine 12's fastest rate, and the pressure of steam supplied to steam turbine 14 is varied during start-up using pressure controllers 40 and 42.

The above-described methods and apparatus facilitate reduced emissions during starting and loading as compared to emissions generated with known combined cycle systems. Such methods and apparatus also facilitate reduced starting and loading time and reduced fuel consumption during the starting and loading event as compared to known combined cycle systems. More specifically, the above-described methods enable combined cycle power plants to start up faster and reach a higher steam turbine loading in a shorter time as compared to other known start-up methods. As such, the methods described herein facilitate reducing the fuel consumption and emissions, while increasing the revenue of a power plant. Further, the methods facilitate decreasing the start time of combined cycle power plants by inducing early high-pressure steam flow from the HRSG. As such, the steam may be admitted to the steam turbine faster, as compared to known combined cycle systems. Moreover, the above-described methods also facilitate reducing the hold time of the gas and steam turbines, thus facilitating decreasing start up time. The decreased start-up times enable the above-described system to achieve a higher plant power output in a shorter time, as compared to other known systems. Further, the decreased start-up time facilitates reaching higher overall plant efficiency earlier, and facilitates producing a greater revenue for customers and lower overall greenhouse emissions, as compared to known combined cycle systems. Moreover, the above-described system and methods facilitate gaining an advantage on dispatch ranking for spinning/not-spinning.

Exemplary embodiments of systems and methods are described and/or illustrated herein in detail. The systems and methods are not limited to the specific embodiments described herein, but rather, components of each system, as well as steps of each method, may be utilized independently and separately from other components and steps described herein. Each component, and each method step, can also be used in combination with other components and/or method steps.

While the invention has been described in terms of various specific embodiments, those skilled in the art will recognize that the invention can be practiced with modification within the spirit and scope of the claims.

What is claimed is:

1. A method for starting a combined cycle power generation system, wherein the system includes a gas turbine and a steam turbine, said method comprising:
loading the gas turbine at a loading rate that is facilitated to be at an increased loading rate;
setting a first predetermined value for a bypass pressure set point for high-pressure steam; and
increasing the first predetermined value to a second predetermined value at a predetermined rate.

2. A method in accordance with claim 1 further comprising:
loading the steam turbine at a bypass pressure set point with the first predetermined value; and
loading the steam turbine at a bypass pressure set point with the second predetermined value.

3. A method in accordance with claim 2 wherein loading the steam turbine at the second predetermined value further comprises increasing the loading of the steam turbine by modulating at least one valve to facilitate controlling a flow of at least one of high-pressure steam, reheat steam, and low pressure steam.

4. A method in accordance with claim 1 wherein increasing the first predetermined value to a second predetermined value further comprises increasing the first predetermined value to a second predetermined value that is between approximately 60% and approximately 100% of a rated pressure of the steam turbine.

5. A method in accordance with claim 1 wherein increasing the first predetermined value to a second predetermined value at a predetermined rate further comprises loading the steam turbine while the first predetermined value is increased to the second predetermined value at the predetermined rate.

6. A method in accordance with claim 1 wherein increasing the first predetermined value to a second predetermined value at a predetermined rate further comprises increasing the first predetermined value to the second predetermined value at the predetermined rate by modulating at least one valve along a bypass path to channel steam away from the steam turbine.

7. A method in accordance with claim 1 further comprising varying a value for a bypass pressure set point for hot reheat steam.

8. A combined-cycle power generation system comprising:
a gas turbine coupled to a first generator;
a steam turbine coupled to a second generator;
a heat recovery steam generator coupled to said steam turbine and said gas turbine, said heat recovery steam generator for supplying steam to said steam turbine;
at least one pressure controller coupled in flow communication with said heat recovery steam generator, said at least one pressure controller is set at a first predetermined value for a bypass pressure set point and is varied such that said first predetermined value is increased to a second predetermined value at a predetermined rate.

9. A combined-cycle power generation system in accordance with claim 8 further comprising at least one steam bypass path in flow communication with said heat recovery steam generator, said at least one pressure controller operatively coupled to said at least one steam bypass path for controlling the bypass pressure set point.

10. A combined-cycle power generation system in accordance with claim 9 further comprising at least one valve along said at least one steam bypass path, said at least one pressure controller operatively coupled to said at least one valve for controlling the bypass pressure set point.

11. A combined-cycle power generation system in accordance with claim 9 wherein said at least one steam bypass path further comprises:
a high-pressure cascade bypass path;
a high-pressure parallel bypass path;
a low-pressure steam bypass path; and
a hot reheat steam bypass path.

12. A combined-cycle power generation system in accordance with claim 11 further comprising:
a first valve in flow communication with said high-pressure cascade bypass path;
a second valve in flow communication with said high-pressure parallel bypass path; and
a third valve in flow communication with said hot reheat steam bypass path.

13. A combined-cycle power generation system in accordance with claim 8 further comprising:
a first valve coupled along a first bypass path, said at least one pressure controller operatively coupled to said first valve for varying the bypass pressure set point; and
a second valve coupled along a second bypass path, said at least one pressure controller operatively coupled to said second valve for varying the bypass pressure set point.

14. A combined-cycle power generation system in accordance with claim 8 wherein at least one pressure controller further comprises:
a first pressure controller configured to control a flow of high-pressure steam; and
a second pressure controller configured to control a flow of hot reheat steam.

15. A combined-cycle power generation system in accordance with claim 14 further comprising:
a first valve coupled along a first bypass path, said first pressure controller operatively coupled to said first valve for varying a high-pressure steam pressure; and
a second valve coupled along a second bypass path, said second pressure controller operatively coupled to said second valve for varying a hot reheat steam pressure.

16. A method for starting a combined cycle power generation system, the system including a gas turbine and a steam turbine, the combined cycle system further includes a heat recovery steam generator, a condenser connected to the steam turbine, a plurality of bypass paths from the heat recovery steam generator to the condenser and from the high-pressure steam piping to the hot reheat steam piping, and at least one pressure controller coupled in flow communication with at least one steam bypass path, said method comprising:
loading the gas turbine at an increased rate;
loading the steam turbine using variable pressure steam by:
setting a bypass pressure set point for high-pressure steam at a first predetermined value using the at least one pressure controller; and
increasing the bypass pressure set point to a second predetermined value at a predetermined rate using the at least one pressure controller.

17. A method in accordance with claim 16 wherein loading the steam turbine further comprises:
loading the steam turbine at a bypass pressure set point with the first predetermined value;
loading the steam turbine while the first predetermined value is increased to the second predetermined value at the predetermined rate; and
loading the steam turbine at a bypass pressure set point with the second predetermined value.

18. A method in accordance with claim 16 wherein loading the steam turbine further comprises:
starting the steam turbine at an initial operating conditions; and
loading the steam turbine at a bypass pressure set point with the first predetermined value after the steam turbine is started.

19. A method in accordance with claim 16 wherein loading the steam turbine further comprises modulating a steam pressure within the at least one bypass path using the at least one pressure controller.

20. A method in accordance with claim 16 further comprising varying a value for a bypass pressure set point for hot reheat steam after the steam turbine is loaded.
